(19) United States
(12) Patent Application Publication
(10) Pub. No.: US 2025/0027803 A1
(43) Pub. Date: Jan. 23, 2025

(54) ELECTRICAL CAPACITANCE VOLUME SENSORS, TESSELLATED ELECTRODES, AND SEGMENTED ELECTRODES FOR CAPACITANCE VOLUME SENSING

(71) Applicant: Tech4Imaging LLC, Columbus, OH (US)

(72) Inventors: Qussai Marashdeh, Columbus, OH (US); Matthew Charleston, Westerville, OH (US); Benjamin Straiton, Hilliard, OH (US)

(21) Appl. No.: 18/751,641

(22) Filed: Jun. 24, 2024

Related U.S. Application Data
(60) Provisional application No. 63/527,841, filed on Jul. 20, 2023.

(51) Int. Cl. G01F 22/00

(52) U.S. Cl. CPC G01F 22/00

(57) ABSTRACT

A system for generating a volume measurement or three-dimensional image of a vessel interior or other object or for determining a quantity of material in a volume, having a symmetrical sensor comprising a plurality of electrodes in a predetermined symmetrical shape arranged in a tessellated pattern for placement around the vessel or the object, wherein the sensor is adapted to provide electric field distribution and sensor sensitivity in three geometric dimensions; the system having a data acquisition electronics in communication with the sensor for receiving input data from the sensor; and a processing system programmed with instructions for executing on the processing system to report a volumetric measurement directly from capacitance volume sensor or through reconstructing a three-dimensional volume-image from the input data collected by the data acquisition electronics. The sensor also includes plates with varying voltage excitations or with a predetermined distribution of excitation and ground subplates.

### CROSS-REFERENCE TO RELATED APPLICATIONS

This application claims priority to U.S. Provisional Patent Application No. 63/527,841 filed on Jul. 20, 2023, which is herein incorporated by reference in its entirety.

### BACKGROUND OF THE INVENTIVE FIELD

Electrical Capacitance Volume Tomography (ECVT) and Adaptive Electrical Capacitance Volume Tomography (AECVT) are soft field tomography modalities that provide 3D images by resolving the measured capacitance back to 3D spatial distributions based on the electric properties of the phases in the imaging domain. See U.S. Pat. Nos. 8,614,707, 10,269,171, 10,806,366, and 10,705,043 incorporated by reference herein. Multi-dimensional flow meters or flow sensors have also been developed for calculating the volumetric flow rate of a multi-phase flow using the same sensor used for measuring the volume fraction. See, e.g., U.S. patent application Ser. No. 18/590,693 incorporated by reference herein. The velocity is measured by cross-correlating measurements of the sensor in multiple layers (e.g., layers of plates). The distance between layers in the sensor determines the velocity resolution. The sensor also preferably provides correlation signals from plates in the same layer for cross-sectional flow velocities.

While imaging with ECVT and AECVT can provide valuable information of phase distribution in a 3D volume, the image reconstruction process is nonlinear, computationally intensive, and can introduce unnecessary error when a full image reconstruction of the volume is not needed. In many applications, knowing a global measurement such as the total volume fraction or mass fraction of the phases inside the measurement region is more important than knowing the distribution of the phases. Additionally, a coarse measurement of phase distribution can be obtained without image reconstruction. These measurements can be made with the same style of sensors and electronics as ECVT and AECVT and share many of the same design requirements. However, without the use of image reconstruction, this technology is referred to as Electrical Capacitance Volume Sensing (ECVS). ECVS is a capacitance-based sensing methodology that utilizes the 3D volumetric sensitivity of the electric field to measure the volume fraction or mass fraction of phases inside the sensing region. Furthermore, the design of the sensor, including the sensing plates' size, shape, number, and layout, has a great effect on the response of the signal with respect to the position, size, and volume fraction of the materials inside. The segmentation of plates into grounded and excite/detect regions, the distribution of voltage along these segments, and the symmetry/tessellation of the sensor design, can all improve the capabilities of ECVS, ECVT, and AECVT by reducing non-linearity in the sensitivities of individual plate pairs and increasing homogeneity of the sensitivity in the sensor as a whole.

### SUMMARY OF THE GENERAL INVENTIVE CONCEPT

This invention introduces the concept of ECVS, where volumetric capacitance sensors are used to gauge the volume of a flow phase or material inside the sensing domain directly from the capacitance measurements by taking advantage of 3D sensitivity distribution without the need for image reconstruction. It also introduces sensor design methods to reduce the nonlinearity of the sensor sensitivity and increase the volumetric senor accuracy for ECVS, ECVT, and AECVT.

These methods include a method and system to maximize homogeneity of the sensitivity in the sensor by basing sensor design on spherical tessellation (other embodiments involve projecting spherical tessellations onto any desired shape), a method to segment plates and incorporate grounded structures into the internal area of the plate, and a method to segment plates into areas of varying voltage.

In one embodiment of the invention, the present invention is a system for generating a three-dimensional sensitivity of a vessel interior or other object or for determining a quantity of material in a volume, the system comprising: a volume sensor device comprising a plurality of electrodes placed around the vessel or the object as in ECVT or AECVT, wherein the sensor device is adapted to provide electric field distribution and sensor sensitivity in three geometric dimensions; data acquisition electronics in communication with the sensor device for receiving input data from the sensor device; a processing system in communication with the data acquisition electronics, the processing system programmed with instructions for executing on the processing system to provide a volume reading of material or flow phase inside the sensor domain from the input data collected by the data acquisition electronics without generating an image.

In one embodiment of the system, the electrodes of the volumetric capacitance sensor device are segmented into sections with varying voltage excitation to distribute the sensor sensitivity more evenly in the sensing domain.

In one embodiment of the system, the electrodes of the volumetric capacitance sensor device are of a closed shape including but not limited to circular, curved, polygonal, regular, or irregular in shape. The three-dimensional capacitance sensor device may be comprised of at least two planes of electrodes to provide sensor sensitivity in the axial and radial directions. In one embodiment, the sensor is adapted to be opened and closed around the region to be imaged.

In one embodiment of the system, the sensitivity matrix of the volumetric sensor is used to weight different capacitance measurements towards volumetric and mass gauging.

In one embodiment of the system, the electrodes of the volumetric capacitance sensor device are composed of active and ground segments to distribute the nonlinearity around the plate edges evenly over the plate surface.

In one embodiment of the system, the capacitance measurements of the volumetric sensor are categorized based on geometry and the ratio between different geometric measurements is used for flow identification.

In one embodiment of the system, the sensor electrodes are in a shape and pattern that tessellates the surface of a sphere such that each vertex where the plates meet has the same number of electrodes meeting at every vertex across the surface of the sphere. The tessellated shape may be a regular polygon or other shape.

In one embodiment of the system, the pattern of electrodes that tessellates the surface of a sphere such that each vertex where the plates meet has the same number of electrodes meeting at every vertex across the surface of the sphere can be projected onto another 3D surface including open and closed surfaces.

In one embodiment of the invention, the present invention is a system for generating a three-dimensional image of a vessel interior or other object or for determining a quantity of material in a volume using ECVT or AECVT, the system comprising: the sensor with electrodes that are in a shape and pattern that tessellates the surface of a sphere such that each vertex where the plates meet has the same number of electrodes meeting at every vertex across the surface of the sphere. The tessellated shape may be a regular polygon or other shape for placement around the vessel or the object, wherein the sensor device is adapted to provide electric field distribution and sensor sensitivity in three geometric dimensions; data acquisition electronics in communication with the sensor device for receiving input data from the sensor device; a processing system in communication with the data acquisition electronics, the processing system programmed with instructions for executing on the processing system to reconstruct a three-dimensional volume-image from the input data collected by the data acquisition electronics.

In one embodiment of the system, the electrodes of the volumetric capacitance sensor device are segmented into sections with varying voltage excitation to distribute the sensor sensitivity more evenly in the sensing domain for the purposes of imaging as in ECVT and AECVT.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one example embodiment of the invention including a sensor in a spherical shape having tessellated electrodes and a data acquisition system (DAS).

FIG. 2 illustrates another alternate design of one embodiment of a sensor having tessellated electrode plates.

FIG. 3 illustrates another alternate design of one embodiment of a sensor having tessellated electrode plates.

FIG. 4 illustrates one embodiment of an adjacent channel or electrode pair for the sensor of FIG. 2.

FIG. 5 illustrates one embodiment of a semi-adjacent channel or electrode pair for the sensor of FIG. 2.

FIG. 6 illustrates one embodiment of an opposite channel or electrode pair for the sensor of FIG. 2.

FIG. 7 illustrates one embodiment of an adjacent channel or electrode pair for the sensor of FIG. 3.

FIG. 8 illustrates one embodiment of a cross channel or electrode pair for the sensor of FIG. 3.

FIG. 9 illustrates one embodiment of an opposite channel or electrode pair for the sensor of FIG. 3.

FIG. 10 illustrates one embodiment of an electrode projected as a planar pentagon for clarity.

FIG. 11 illustrates one embodiment of a sensor electrode having concentric electrodes.

FIG. 12 illustrates one embodiment of a sensor electrode divided into subplates.

FIG. 13 illustrates one embodiment of a sensor electrode having an inscribed circular electrode.

FIG. 14 illustrates one embodiment of a sensor electrode having a top array and a bottom array that can be opened and closed around a tank or vessel to be sensed or imaged.

FIG. 15 illustrates one embodiment of a sensor with segments activated in alternating pattern of voltage and ground to homogenize the sensitivity between sender and receiver electrodes and increase the accuracy of volume and mass gauging of material inside the sensor.

FIG. 16 illustrates one embodiment of a sensor with segments activated in a tapered pattern of voltage to homogenize the sensitivity between sender and receiver electrodes and increase the accuracy of volume and mass gauging of material inside the sensor.

FIG. 17 illustrates one embodiment of a sensor with segments activated with voltage while ground lines pass in between the segments to homogenize the sensitivity between sender and receiver electrodes and increase the accuracy of volume and mass gauging of material inside the sensor.

FIG. 18 illustrates one embodiment of a sensor with segments arranged concentrically with voltage excitation at the edge while grounded at the center.

FIG. 19 illustrates one embodiment of a sensor with segments activated with voltage in a spiral arrangement while ground lines pass in between parallel to the activation segments.

FIG. 20 illustrates one embodiment of a sensor with a tessellated design where the plate is projected from the surface of a sphere to the surface of a cylinder.

FIG. 21 illustrates one embodiment of a sensor with a tessellated design where the plate is projected from the surface of a sphere to the surface of a cylinder to the surface of an ellipsoid cap.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

This invention is a method for ECVS, ECVT, and AECVT sensor design that maximizes symmetry in sensor design by relying on tessellations (e.g., electrodes configured and arranged in a tessellated pattern where each vertex where the plates meet has the same number of electrodes meeting at every vertex across the surface of the sphere). The sensor design objectives are to maximize symmetry while also utilizing all the surface area available. Covering more of the surface area with sensor plates increases the spatial distribution of sensor and the signal to noise ratio, and increases the image resolution. In the preferred embodiment of the present invention, the sensor is a three-dimensional sensor or 3D (preferably in a spherical shape) with electrode plates. In the preferred embodiment, the sensing domain the electrode plates are tessellated around is spherical in shape. This improves the symmetry of the design when measuring 3D volumes. The spherical tessellation distributes the sensitivity better in a 3D volume than other sensor designs.

As the sphere is the most symmetrical 3D object, the sensor design is based initially on spherical tessellations. In the preferred embodiment, the tessellations are of regular shapes (platonic solids) that provide maximum symmetry and cover the surface area of the sphere. Non-spherical sensor designs can be obtained by projecting the tessellated spherical design onto the desired object surface area. In other words, a spherical tessellation is projected outward from the centroid (or center of gravity) of an irregular 3D volume. This maps the spherical tessellation onto a non-spherical object. For example, to design a cylindrical sensor, the sphere would be placed at the center of the region, where the center of the sphere is at the same point as the centroid of the cylinder. A line is then drawn from the centroid to each vertex of each plate and extended outward. The intersection of each line with the surface of the cylinder is a point, and those points can be reconstructed into shapes. In this way, the area of the shape will increase as the location of the shape is further away from the centroid of the object.

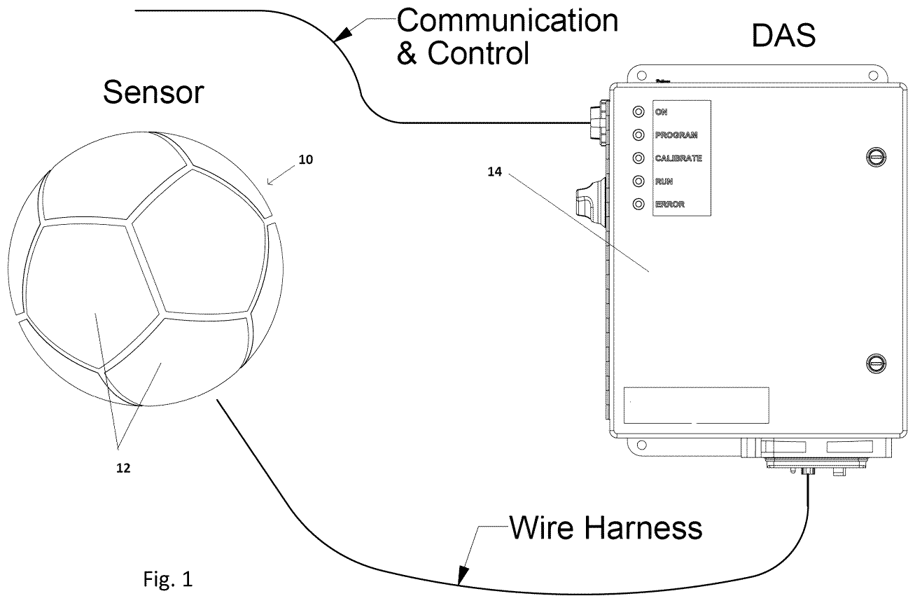

FIG. 1 illustrates one example embodiment of the invention including a sensor 10 in a spherical shape having tessellated electrodes 12 and a data acquisition system (DAS) 14. The DAS is operationally connected to the sensor via a wire harness and to a control (processing system) using control/communication wiring. The present invention relates to a sensor design with maximized symmetry for homogenized sensitivity.

The tessellated sensor design can be used to sense the volume or mass ratio of phases inside the region, without performing an image reconstruction. Raw signal values or averages of the signal values of various channel types can be used in algorithms or decision trees to improve the accuracy of volume or mass fraction calculation. In this case the higher degree of symmetry is also beneficial, as relationships between the sensitivity of channel types can be calibrated empirically or determined through other means.

In one embodiment of the present invention, spherical tessellations are then projected onto any 3D shape. In one embodiment of the invention, independent images can be constructed from different capacitance measurement types into one global image through means of image processing.

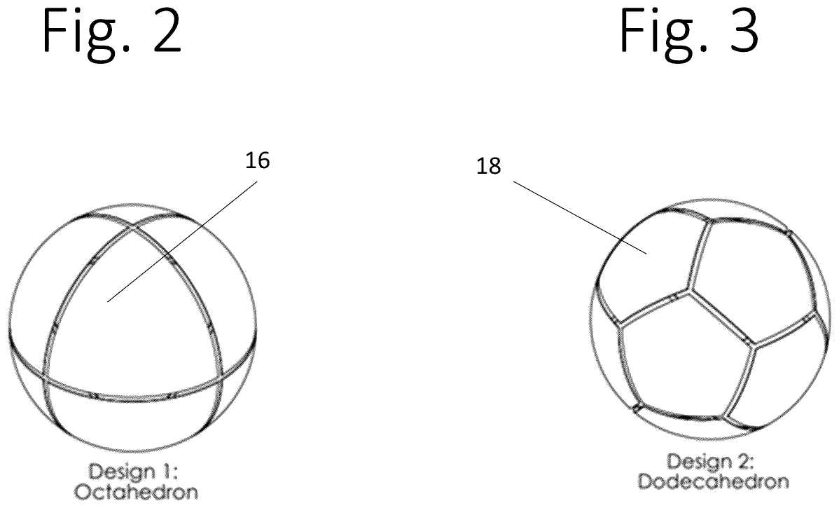

FIG. 2 illustrates another alternate design of one embodiment of a sensor having tessellated electrode plates 16. FIG. 3 illustrates another alternate design of one embodiment of a sensor having tessellated electrode plates 18.

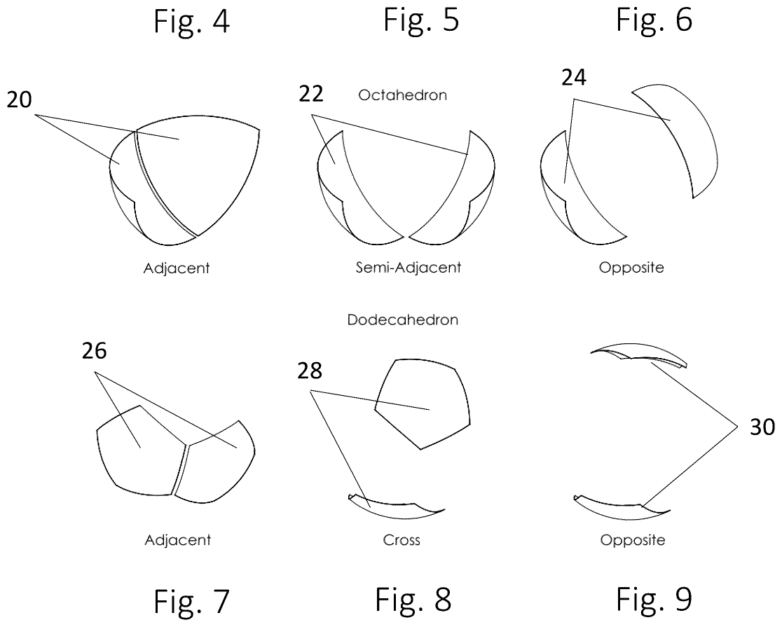

As image reconstruction is most efficient when conducted on measurements from channels with similar types as it has to deal with less irregularities in the sensor sensitivity, the measured capacitance can be divided into categories of similar channel types and an image reconstruction can be performed on each set of similar channels independently. The independent images can then be combined into one global image through image processing. FIG. 4 illustrates one embodiment of an adjacent channel or electrode pair 20 for the sensor of FIG. 2. The embodiment also allows for volume measurement directly from capacitance measurements and without going through image reconstruction.

FIG. 5 illustrates one embodiment of a semi-adjacent channel or electrode pair 22 for the sensor of FIG. 2. FIG. 6 illustrates one embodiment of an opposite channel or electrode pair 24 for the sensor of FIG. 2. FIG. 7 illustrates one embodiment of an adjacent channel or electrode pair 26 for the sensor of FIG. 3. FIG. 8 illustrates one embodiment of a cross channel or electrode pair 28 for the sensor of FIG. 3. FIG. 9 illustrates one embodiment of an opposite channel or electrode pair 30 for the sensor of FIG. 3. The symmetry of a sensor is measured by the number of channel types it provides (opposite plates, adjacent plates, etc.).

As spherical tessellations have a limited number of available plates, the number of plates can be increased by concentric spherical tessellations that repeat the same shape, or by diving tessellated plates into subplates.

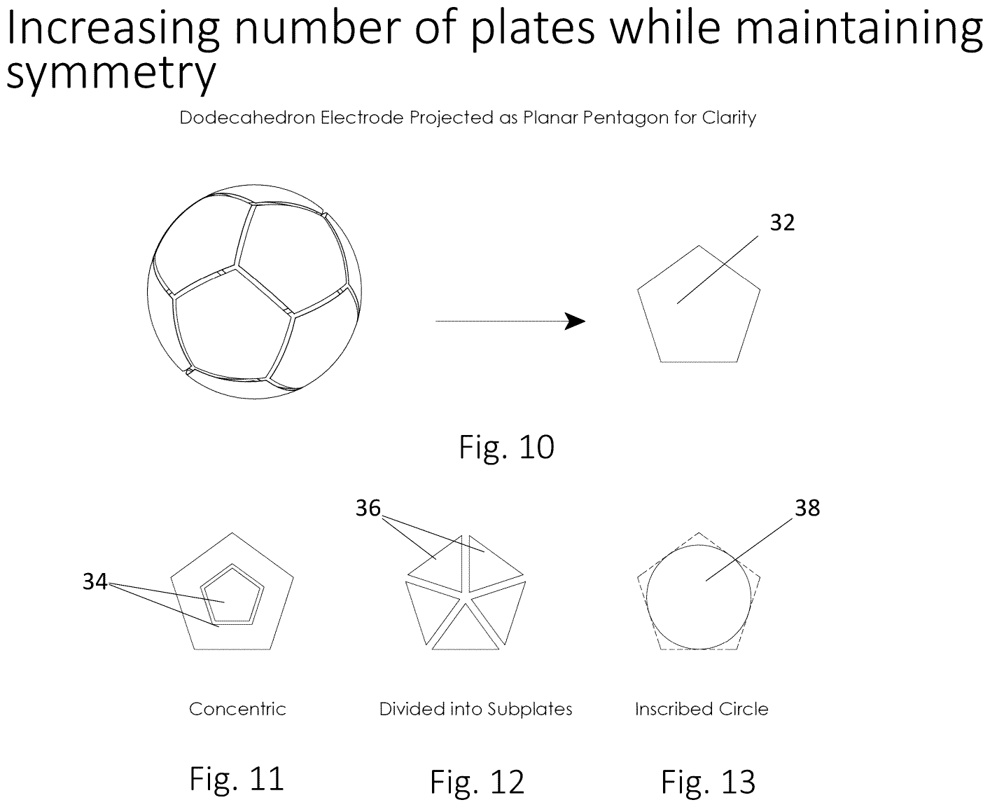

FIG. 10 illustrates one embodiment of an electrode projected as a planar pentagon 32 for clarity.

Circles can be inscribed inside tessellated plates while maintaining symmetry. FIG. 11 illustrates one embodiment of a sensor electrode having concentric electrodes 34.

FIG. 12 illustrates one embodiment of a sensor electrode divided into subplates 36. FIG. 13 illustrates one embodiment of a sensor electrode having an inscribed circular electrode 38 (replacing tessellated shapes with circles for reducing singularities in measured capacitance).

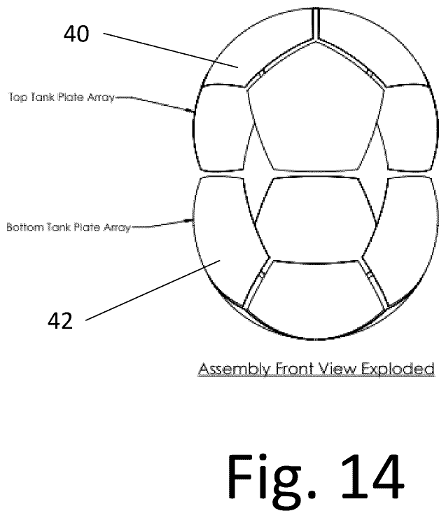

FIG. 14 illustrates one embodiment of a sensor electrode having a top array 40 and a bottom array 42 that can be opened and closed around a tank or vessel to be sensed or imaged.

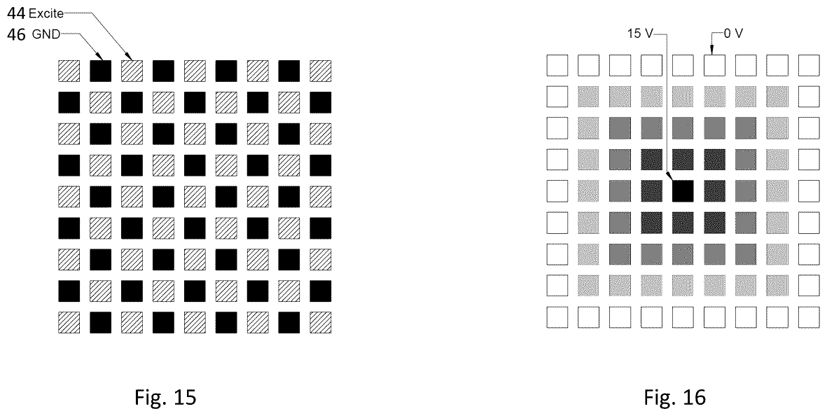

The sensor sensitivity for direct volume fraction measurement and for image reconstruction can benefit from distributing the charge accumulation at the edge of the plate to the surface of the plate. FIG. 15 illustrates one embodiment of a sensor with electrode sub-plate or segments activated in an alternating pattern of voltage 44 and ground 46 to homogenize the sensitivity between sender and receiver electrodes and increase the accuracy of volume and mass gauging of material inside the sensor.

FIG. 16 illustrates one embodiment of a sensor with segments activated in a tapered pattern of voltage to homogenize the sensitivity between sender and receiver electrodes and increase the accuracy of volume and mass gauging of material inside the sensor.

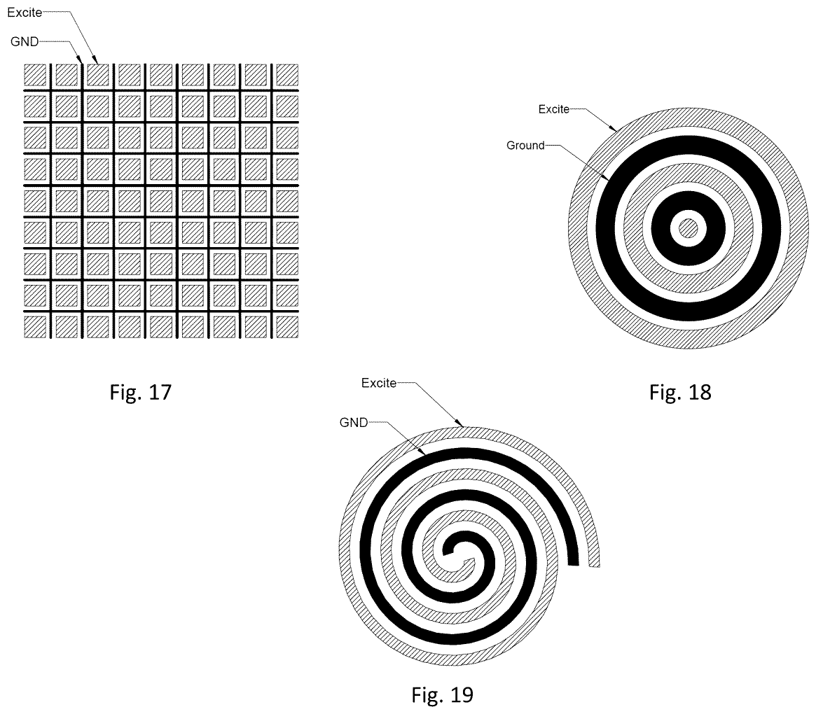

FIG. 17 illustrates one embodiment of a sensor with sub-plates or segments activated with voltage while ground lines pass in between the segments to homogenize the sensitivity between sender and receiver electrodes and increase the accuracy of volume and mass gauging of material inside the sensor.

FIG. 18 illustrates one embodiment of a sensor with segments arranged concentrically with voltage excitation at the edge while grounded towards the center. This concentric pattern can be extended further with active concentric layers surrounding the ground and so forth. The segments are intended to homogenize the sensitivity between sender and receiver electrodes and increase the accuracy of volume and mass gauging of material inside the sensor.

FIG. 19 illustrates one embodiment of a sensor with segments activated with voltage in a spiral arrangement while ground lines pass in between parallel to the activation segments. The segments are intended to homogenize the sensitivity between sender and receiver electrodes and increase the accuracy of volume and mass gauging of material inside the sensor.

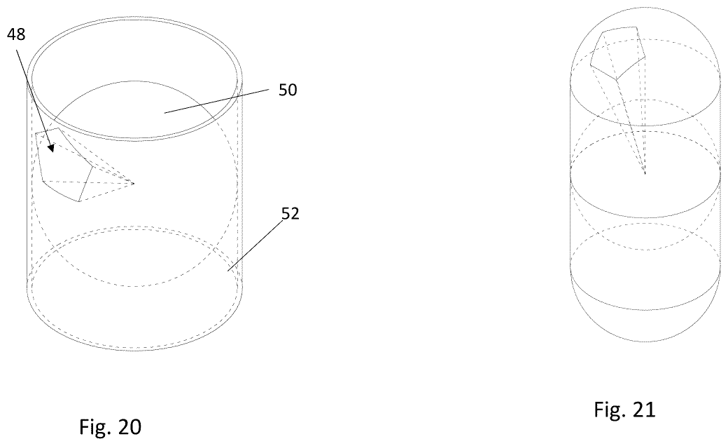

FIG. 20 illustrates one embodiment of a sensor with a tessellated design where the plate 48 is projected from the surface of a sphere 50 to the surface of a cylinder 52. The tessellated projection is intended to homogenize the sensitivity between sender and receiver electrodes and increase the accuracy of volume and mass gauging of material inside a sensor other than spherical in shape.

FIG. 21 illustrates one embodiment of a sensor with a tessellated design where the plate is projected from the surface of a sphere to the surface of a cylinder to the surface of an ellipsoid cap. The tessellated projection is intended to homogenize the sensitivity between sender and receiver electrodes and increase the accuracy of volume and mass gauging of material inside a sensor other than spherical in shape. In each arrangement of excitation and ground for better distribution of the sensitivity, the arrangement can also achieve this objective by a tapered excitation voltage.

Although the aforementioned describes embodiments of the invention, the invention is not so restricted. It will be apparent to those skilled in the art that various modifications and variations can be made to the disclosed embodiments of the present invention without departing from the scope or spirit of the invention. Accordingly, other tessellated sensors and methods of using them are fully within the scope of the claimed invention. Therefore, it should be understood that the apparatuses and methods described herein are illustrative only and are not limiting upon the scope of the invention, which is indicated by the following claims.

What is claimed is:

1. A system for sensing the contents of a vessel interior, volume or other object for determining a quantity of material in a volume or mass fraction, the system comprising:
a sensor comprising a plurality of electrodes or plates in a capacitance sensor plate arrangement, wherein the sensor is adapted to provide electric field distribution and sensor sensitivity in three geometric dimensions; and
a processing system, the processing system programmed with instructions for executing on the processing system to calculate a material volume from information collected by the sensor.

2. A system according to claim 1, wherein the electrodes or plates are divided into sub-plates or segments.

3. A system according to claim 2, wherein the sub-plates or segments are activated with different voltage excitations or ground to distribute a charge accumulation across the plate.

4. A system according to claim 3, wherein the sub-plates or segments are arranged in an alternating pattern of voltage excitation sub-plates and ground sub-plates.

5. A system according to claim 1, wherein the sensor is used to measure an amplitude or phase of a received signal and at different frequencies.

6. A system according to claim 1, wherein the sensor sensitivity is used to weight measurements from the sensor for accurate volumetric and mass gauging of material in the sensor domain.

7. A system according to claim 1, wherein the electrodes or plates are tessellated on the surface of a sphere such that all electrode or plate shapes are identical, and each vertex of plates touches the same number of plates as all other vertices.

8. A system according to claim 7, wherein the electrodes or plates are inscribed circles in a tessellated configuration.

9. A system according to claim 7, wherein the electrodes or plates are further segmented inside the tessellated shapes.

10. A system according to claim 1, wherein the electrodes or plates are projected from a spherical surface onto another open or closed surface.

11. A system according to claim 1, wherein the sensor is categorized based on plate geometry for identification of flow pattern or material location.

12. A system according to claim 1, wherein the sensor is comprised of at least two planes of electrodes or plates to provide sensor sensitivity in the axial and radial directions.

13. A system according to claim 1, wherein the sensor is adapted to be opened and closed around the region to be imaged.

14. A system for generating a three-dimensional image of a vessel interior or other object or for sensing the contents of a vessel interior, volume or other object, the system comprising:
a sensor comprising a plurality of electrodes or plates where the electrodes or plates are tessellated on a surface of a sphere such that all electrode or plate shapes are identical and each vertex of plates touches the same number of plates as all other vertices, wherein the sensor is adapted to provide electric field distribution and sensor sensitivity in three geometric dimensions; and
a processing system, the processing system programmed with instructions for executing on the processing system to calculate material volume inside the sensor from information collected by the sensor.

15. A system according to claim 14, wherein the electrodes or plates are inscribed circles in a tessellated configuration.

16. A system according to claim 14, wherein the electrodes or plates are further segmented inside the tessellated shapes into sub-plates or segments.

17. A system according to claim 14, wherein the electrodes or plates are projected from the spherical surface onto another open or closed surface.

18. A system according to claim 14, wherein the electrodes or plates of the sensor are circular, regular, irregular, polygonal, triangular or trapezium in shape.

19. A system according to claim 14, wherein the sensor is comprised of at least two planes of electrodes or plates to provide sensor sensitivity in the axial and radial directions.

20. A system according to claim 14, wherein the sensor is adapted to be opened and closed around a region to be imaged.

21. A system according to claim 14, wherein the system is adapted to combine independent images reconstructed from different capacitance measurement types into one global image through image processing.

22. A system according to claim 16, wherein the sub-plates or segments are activated with different voltage excitations or ground to distribute a charge accumulation across the plate.

23. A system for generating a three-dimensional image of a vessel interior or other object or for sensing the contents of a vessel interior, volume or other object, the system comprising:
a sensor of non-spherical shape comprising a plurality of electrodes or plates where the electrodes or plates are configured by projecting a tessellated spherical design onto a surface of the sensor, wherein the sensor is adapted to provide electric field distribution and sensor sensitivity in three geometric dimensions; and
a processing system, the processing system programmed with instructions for executing on the processing system to calculate material volume inside the sensor from information collected by the sensor.

24. A system according to claim 23, wherein the sensor is adapted to be opened and closed around a region to be imaged.

25. A system according to claim 23, wherein the system is adapted to combine independent images reconstructed from different capacitance measurement types into one global image through image processing.

26. A system according to claim 23, wherein the electrodes or plates are configured with concentric sub-plates.

27. A system according to claim 23, wherein the electrodes or plates are divided into sub-plates or segments.

28. A system according to claim 23, wherein the electrodes or plates are inscribed with circles for reducing singularities in measured capacitance.

29. A system for generating a three-dimensional image of a vessel interior or other object or for sensing the contents of a vessel interior, volume or other object, the system comprising:
a sensor comprising a plurality of electrodes or plates where the electrodes or plates are segmented into smaller sub-plates or segments wherein the sub-plates or segments are each designated as excitation or ground, wherein the sub-plates or segments are activated with different voltage excitations or ground to distribute a charge accumulation across the plates, wherein the sensor is adapted to provide electric field distribution and sensor sensitivity in three geometric dimensions; and
a processing system, the processing system programmed with instructions for executing on the processing system to calculate volume of material inside the sensor from information collected by the sensor.

30. A system according to claim 29, wherein the sensor is used to measure an amplitude or phase of a received signal.

31. A system according to claim 29, wherein the sensor is used to measure an amplitude or phase of a received signal and at different frequencies.

32. A system according to claim 29, wherein the electrodes or plates of the sensor are circular, regular, irregular, polygonal, triangular or trapezium in shape.

33. A system according to claim 29, wherein the sensor is comprised of at least two planes of electrodes to provide sensor sensitivity in the axial and radial directions.

34. A system according to claim 29, wherein the sensor is adapted to be opened and closed around a region to be imaged.

35. A system according to claim 29, where the segmentation includes a continuous or ground screen throughout each plate.

36. A system according to claim 29, where the segmentation includes concentric shapes.

37. A system according to claim 29, where the segmentation includes intertwined spirals.

38. A system according to claim 29, wherein the sub-plates or segments are activated with different voltage excitations or ground to distribute a charge accumulation across the plate.

39. A system according to claim 14, wherein the sensor is used to measure an amplitude or phase of a received signal and at different frequencies.

40. A system according to claim 17, wherein the electrodes or plates of the sensor are circular, regular, irregular, polygonal, triangular or trapezium in shape.
